(19) United States
(12) Patent Application Publication
(10) Pub. No.: US 2008/0001132 A1
(43) Pub. Date: Jan. 3, 2008

(54) Electric winch

(76) Inventor: Shih Jyi Huang, Taipei (TW)

Correspondence Address: BACON & THOMAS, PLLC, 625 SLATERS LANE, FOURTH FLOOR, ALEXANDRIA, VA, 22314, US

(21) Appl. No.: 11/453,809

(22) Filed: Jun. 16, 2006

(51) Int. Cl. B66D 1/12

(52) U.S. Cl. 254/362

(57) ABSTRACT

An electric winch includes a motor, a speed reducer, a rope shaft, a rope wound around the rope shaft for lifting up or lowering down a heavy load, a clutch, two fix bases, two fix rods, a base plate, and a controller. The motor rotates the speed reducer and then the rope shaft for winding or unwinding the rope. The clutch can connect or disconnect the speed reducer to or from the rope shaft. The fix base is respectively positioned between the motor and the rope shaft and also between the speed reducer and the rope shaft. The fix rods are positioned between the fix bases for securing the distance between the two fix bases. The base plate is positioned on the fix rods, and the controller is firmly mounted on the base plate, with the cap covering over the controller and the base plate for hiding them.

### BACKGROUND OF THE INVENTION

1. Field of the Invention

This invention relates to an electric winch, particularly to one provided with a controller.

2. Description of the Prior Art

An electric winch is used for winding or unwinding a wire rope to hang up or lower down a heavy load, such as lifting up it to a high floor of a building, or lifting up an automobile fallen in a deep valley. There are many kinds of conventional electric winches, and one of them 10 shown in FIG. 1 includes a motor 11, terminals provided on the motor 11 for connecting electric wires to be connected with or disconnected from a controller that is used for rotating the shaft of the motor 11 clockwise or counterclockwise. Further a speed reducer 12 is connected with the shaft of the motor 11, and the speed reducer 12 is provided with a planetary gear unit for rotating a rope shaft 13 for winding or unwinding a wire rope (not shown) thereon. Further a clutch 14 is provided at one side of the rope shaft 13 in the speed reducer 12, having a clutch rod 15 extending upward. When the clutch rod 15 is lowered down or lifted up, the rope shaft 13 is connected to or disconnected from the speed reducer 12. In addition, a fix base 16 is positioned between the motor 11 and the rope shaft 13, and also between the speed reducer 12 and the rope shaft 13, but the fix base 16 is not connected to the rope shaft 13. Moreover, two fix rods 17 are provided tightly between the top of the two fix bases 16 by bolts, having a accurate length equal to the distance between the two fix bases 16 so that the transmitting movement of the parts of the device may be stable and smooth, without errors, enabling the rope shaft 13 rotate smoothly whether clockwise or counterclockwise.

However, the function of the two fix rods 17 is to ensure the accuracy of the distance of the two fix bases 16. In the conventional electric winch they have only that function, but it may also be used for other functions so as to make them more useful.

### SUMMRY OF THE INVENTION

This invention has been devised to offer an electric winch, which is provided with a controller to combine with fix rods.

The feature of the invention is a controller provided on a basic plate and electrically connected to a motor for rotating a speed reducer and then a rope shaft for winding or unwinding a wire rope for lifting up or lowering down a heavy load, and a fix base provided between the motor and the rope shaft and also between the speed reducer and the rope shaft and secured by fix rods to stabilizing the distance between the two fix bases. The fix rods and the basic plate are combined with linking members

The linking members are shaped as inverted Ω and respectively have a threaded hole in one side and a hook formed on the other side and located higher than the side of the threaded hole. The basic plate has round holes and square holes to respectively correspond to the threaded holes and hooks of the linking members.

The basic plate further has plural threaded holes to correspond to plural recesses formed in plural connectors extending from the bottom of the controller for securing the controller on the basic plate.

### BRIEF DESCRIPTION OF DRAWINGS

This invention will be better understood by referring to the accompanying drawings, wherein:

FIG. 1 is a partly exploded perspective view of a known conventional electric winch;

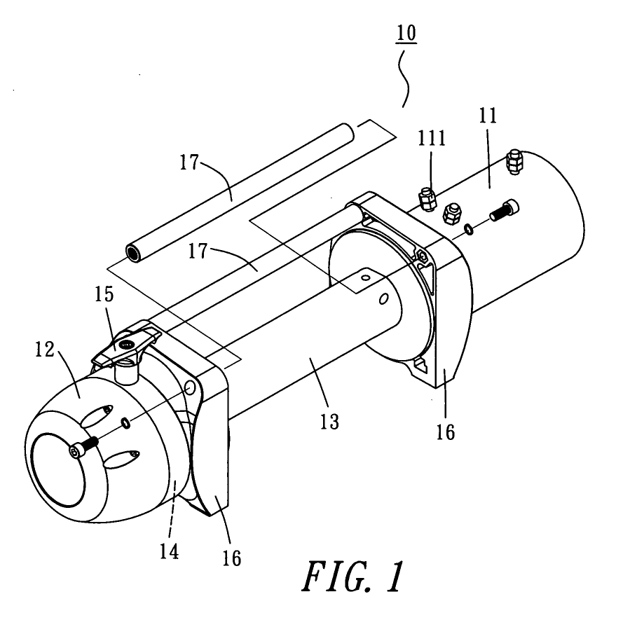

FIG. 2 is an exploded perspective view of an electric winch in the present invention;

FIG. 3 is a perspective view of a partial combination of the electric winch in the present invention;

FIG. 4 is a partial cross-sectional view of FIG. 3; and,

FIG. 5 is a perspective view of the electric winch in the present invention.

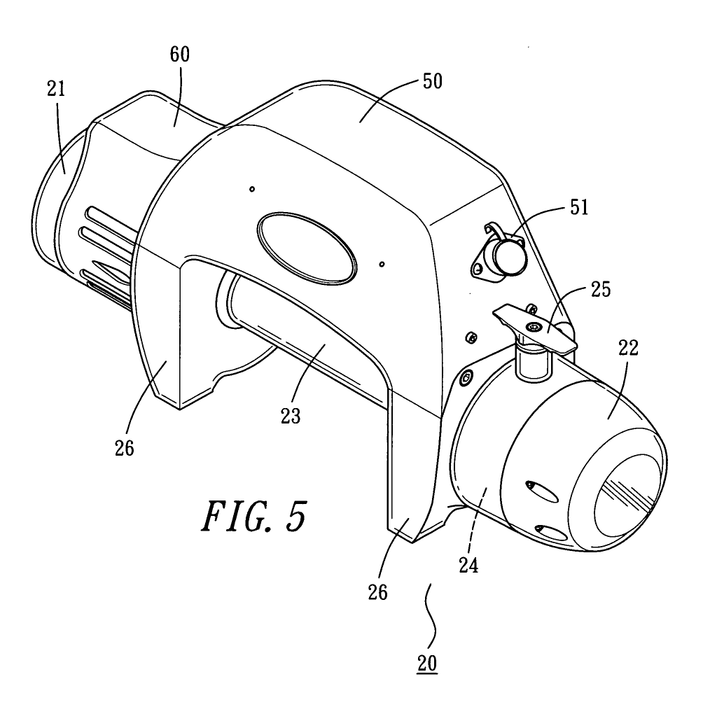

### DETAILED DESCRIPTION OF THE PREFERRED EMBODIEMNT

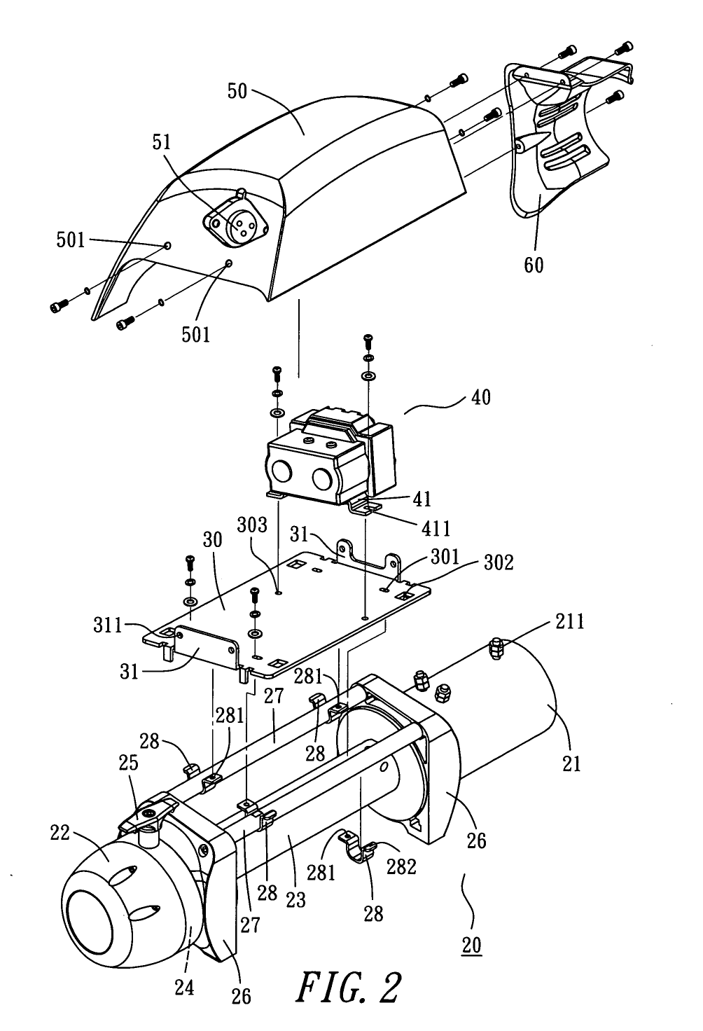

A preferred embodiment of an electric winch in the present invention, as shown in FIG. 2, has almost the same structure of the conventional electric winch described above, including a motor 21, some terminals 211, a speed reducing device 22, a rope shaft 23, a clutch 24, a clutch rod 25, two fix bases 26, and two fix rods 27 as provided in the conventional one and other parts of linking members 28, a basic plate 30, a linking plate 31, a controller 40, a cap 50 and a shell 60.

In the present invention, the two linking members 28 are added to support respectively the two fix rods 27 and to connect the fix rods 27 with the basic plate 30, having a shape of an inverted Ω, and a threaded hole 281 on one side, and a hook 282 on the other side located higher than the side of the threaded hole 281.

Further, the base plate 30 is provided with a hole 301 corresponding to the threaded hole 281 of each linking member 28, a square hole 302 corresponding to the hook 282, and two threaded holes 303 spaced apart in an intermediate portion a littlie near to the right side.

The linking plate 31 is provided respectively at two sides of the base plate 30, having some threaded holes 311 spaced apart.

In addition, the controller 30 has a connector 41 extending outward from two sides of the bottom and formed with a recess to correspond to the threaded hole 303 of the base plate 30 for receiving bolts.

The cap 50 faces downward, having a socket 51 on one side for the plug of a wired remote controller to insert for electric connection and two holes 501 respectively in two sides to correspond to the threaded holes 311 of the linking plate 31.

The cover 60 is placed over the motor 21 and firmly connected with the cap 50 with bolts,

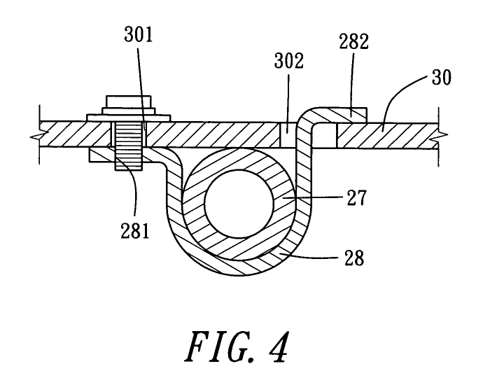

In assembling, firstly, place the base plate 30 on the two fix rods 27, and insert the hooks 282 through the square holes 302, screw bolts in the holes 301 of the base plate 30 and further in the threaded holes 281 of the linking members 28, as shown in FIG. 4. Then the base plate 30 is firmly combined with the fix rods 27.

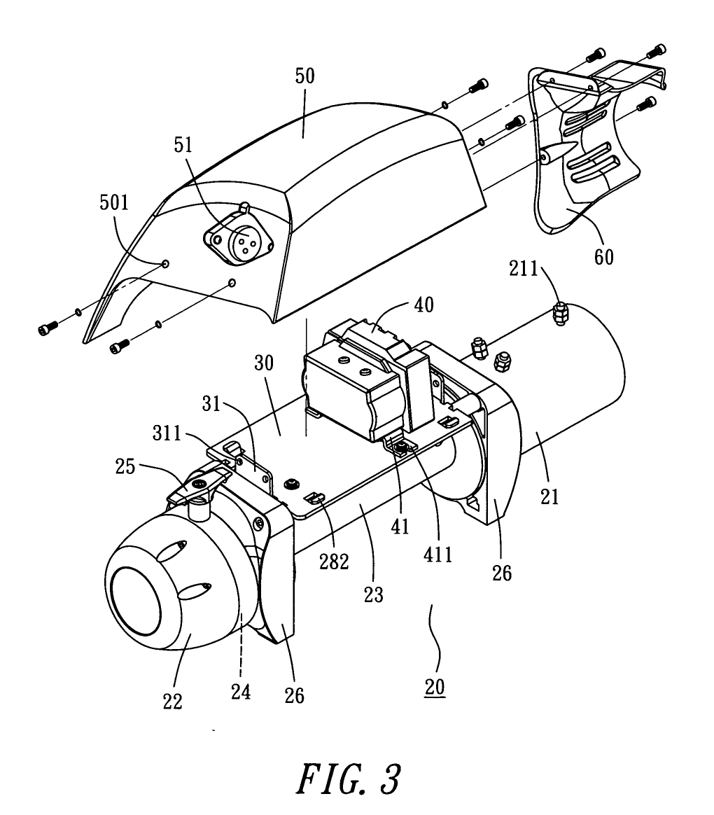

Next, the controller 40 is positioned on the base plate 30, with the recesses of the connectors 41 facing the threaded hole 303 of the base plate 30 for bolts screwing the both tightly together, as shown in FIG. 3.

Then the controller 40 is connected with the terminals 211 of the motor 21 by electric wires, and also with the connecting member 51.

Lastly, the cap 50 is placed over the controller 40 and the base plate 30 and screwed tightly with the both by bolts screwing in the holes 501 and further the threaded holes 311 of the base plate 30. Then the cover 60 is combined sidewise and tightly with the cap 50 by bolts, finishing the assembly of the electric winch 10, with the terminals and the electric wires hidden inside to beautify the appearance of the winch 10.

Thus, the electric winch 10 according to the present invention has an advantage that the controller 40 is assembled on the base plate 30 by utilizing the presence of the fix rods 27, removing the disadvantage of the conventional electric winch described above that the controller is obliged to be positioned somewhere outside the winch itself. Then the connecting member 51 can be used for connecting a wired remote controller for controlling clockwise and counterclockwise rotation of the motor 20.

While the preferred embodiment of the invention has been described above, it will be recognized and understood that various modifications may be made therein and the appended claims are intended to cover all such modifications that may fall within the spirit and scope of the invention.

What is claimed is:

1. An electric winch comprising:
a motor having a shaft;
a speed-reducer connected to said shaft of said motor;
a rope shaft positioned between said motor and said speed reducer and rotated by said speed reducer for winding or unwinding a wire rope wound thereon, said wire rope having its lower end for hanging a heavy load;
plural fix bases positioned between said speed reducer and said rope shaft;
plural fix rods provided firmly between said fix bases for securing stably a distance between said fix bases; and,
characterized by a base plate that is positioned on said fix rods and combined tightly by plural linking members supporting said fix rods by bolts screwed with said base plate from under, a controller fixed firmly on said base plate and electrically connected to said motor, a cap provided to cover over said controller and said basic plate for hiding them.

2. The electric winch as claimed in claim 1, wherein said linking members are shaped as an inverted Ω, respectively having a threaded hole in one side and a hook at the other side, said hook positioned higher than said side with said threaded hole; said base plate is further provided with holes to correspond to said threaded holes and square holes to correspond to said hooks.

3. The electric winch as claimed in claim 1, wherein said base plate is further provided with plural threaded holes, and said controller has plural connectors extending outward from its bottom, said connectors having a recess to correspond to said threaded holes of said base plate.

4. The electric winch as claimed in claim 1, wherein a shell is provided for covering said motor, connected firmly to said cap by bolts.
